(19) United States
(12) Patent Application Publication
(10) Pub. No.: US 2012/0216438 A1
(43) Pub. Date: Aug. 30, 2012

(54) CONTINUOUS DISPLAY ARRANGEMENT

(76) Inventor: Miles Andrew Harris, Halifax (GB)

(21) Appl. No.: 13/505,653

(22) PCT Filed: Nov. 19, 2010
(86) PCT No.: PCT/GB10/02127

§ 371 Date: May 2, 2012

(30) Foreign Application Priority Data
Nov. 21, 2009 (GB) 0920465.2
May 10, 2010 (GB) 1007717.0

(51) Int. Cl. G09F 17/00

(52) U.S. Cl. 40/604

(57) ABSTRACT

A display arrangement includes at least two banners adapted to be displayed side-by side to form a continuous display. Adjacent edges of the banners are adapted to overlap one another by a predetermined overlap area. The overlap area of one banner bears identical material to the overlap area of the other banner. Each banner is secured to a first rod along another edge and these rods are adapted to connect together in such a way that the banners are retained in a side-by-side relationship with said predetermined overlap banner areas overlapping one another. This forms a continuous display across the two banners so that the display arrangement gives the appearance of comprising only a single banner, the joint between the banners being difficult to discern. In some embodiments, one of the banners is secured to a roller-banner stand that is adapted to connect to and thereby support the other banner.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a display arrangement for use in the presentation of graphical or pictorial information and in particular to a continuous display arrangement that is readily transportable.

2. Description of Related Art Including Information Disclosed Under 37 CFR 1.97 and 37 CFR 1.98

Display arrangements for use in the presentation of information conventionally comprise large banners of paper or plastics material that are printed with images or graphics for use in advertising and decorative purposes in retail outlets, exhibitions and other similar contexts. Such banners may be hung from walls and ceilings but to be shown to best advantage are preferably provided with a mount or frame. If a rigid mount is used to frame a large display, then this has the disadvantage that the display becomes unwieldy and difficult to transport. One solution to this problem was the development of light-weight mounts but these tended to be easily damaged. Another solution was the development of geodetic folding frames, commonly referred to as “pop-ups” in the art. However, these are relatively expensive to produce, require a significant amount of space in which they can be set up as well as being large and heavy to transport. Other units exist called “roller-banner stands”. These comprise banners that are wound around a spring-loaded roller in the same manner as a window blind. They take up less space than pop-ups and are robust while being lightweight and compact to transport. They are, however, narrow and to produce a large display it is necessary to use two or more stands side-by-side. In this case, the banner is in two or more parts and these parts have to be joined to produce a continuous display. In pop-ups magnetic strips are used to connect two side-by-side banners together to produce a continuous display. However, roller-banners with magnetic strips along their edges will not roll up into a casing for transportation. Currently, therefore, it is not possible to use roller-banners to form a continuous display. In any event, roller-banner stands have end plates to support the rollers which produce a gap between the banners of side-by-side roller-banner stands.

It is an object of the present invention to provide a display arrangement that overcomes or substantially mitigates the aforementioned problems and that provides a continuous display arrangement using two or more banners to provide a substantially uninterrupted display. In addition, it is an object of the present invention to provide a continuous display arrangement using one or more roller-banner stands that overcomes or substantially mitigates the aforementioned problems with roller-banners.

### BRIEF SUMMARY OF THE INVENTION

According to the present invention there is provided a display arrangement comprising at least two banners adapted to be displayed side-by side to form a continuous display, adjacent edges of the banners being adapted to overlap one another by a predetermined overlap area, the overlap area of one banner bearing identical material to the overlap area of the other banner, and each banner being secured to a first rod along another edge thereof, which first rods are adapted to connect together in such a way that the banners are retained in a side-by-side relationship with said predetermined overlap banner areas overlapping one another.

Preferably, the first rods are adapted to connect together by means of a spigot that joins to at least one of the rods in a male/female joint. Advantageously, the spigot projects from one end of one first rod and is capable of being inserted in a channel or recess at one end of the other first rod.

Preferably also, the predetermined overlap area of at least one of the banners projects beyond the end of said first rod in a direction parallel to its first rod. Advantageously, the predetermined overlap area of each banner is trapezoidal in shape with the parallel sides of the trapezoidal area being normal to the longitudinal axis of the rod to which the banner is secured.

Preferably also, the first rods are secured to top edges of the banners.

Preferably also, each banner is secured to a second rod on an edge opposing said other edge, the second rods of the two banners being adapted to be connected together in the same way as said first rods. Alternatively, one of the banners is secured to a second rod on an edge opposing said other edge and the other of the banners is secured to a stand adapted to connect to the second rod of said one banner.

Preferably also, the arrangement comprises three banners wherein two stands each comprising an other banner are provided, the stands being adapted to connect respectively to the ends of the second rod of said one banner whereby said one banner is supported between said stands.

Preferably also, the stands comprise roller-banner stands.

Preferably also, each stand comprises a casing and the other banner of said stand is secured to a spring-loaded roller that is located within the casing and that is operable to rotate either to roll up said other banner around itself within the casing or to allow withdrawal of the other banner from the casing for display purposes.

Preferably also, said first rods are each adapted to be secured to one end of at least one upright pole that supports the banner, the other end of which pole is connected to the stand.

Preferably also, the first rods comprise a substantially hollow extrusion within which said other edges of the banners are respectively secured. Advantageously, the first rods have a transverse cross-sectional profile that defines separate longitudinally extending recesses along the length of the rod. Preferably, one of the recesses is used to secure the banner to the first rod and the other of the recesses is used to receive a spigot to connect the rod to an adjoining first rod.

Other preferred but non-essential features of the various aspects of the present invention are described in the dependent claims appended hereto.

### BRIEF DESCRIPTION OF THE DRAWINGS

The present invention will now be described by way of example with reference to the accompanying drawings, in which:

FIG. 1 is a schematic front elevation of a display arrangement comprising two banners adapted to be displayed side-by side to form a continuous display but prior to this display being formed;

FIG. 2 is a view similar to FIG. 1 showing the banners after the continuous display has been formed;

FIG. 3 is a view similar to FIG. 1 of a display arrangement in accordance with the present invention but comprising five banners;

FIG. 4 is a view similar to FIG. 3 showing the banners after the continuous display has been formed;

FIG. 5 is a schematic side view of a roller-banner stand used to form the display arrangement shown in FIGS. 3 and 4; and

FIG. 6 is a view to an enlarged scale of the lower part of an alternative embodiment of stand for forming part of a display arrangement in accordance with the present invention.

### DETAILED DESCRIPTION OF THE INVENTION

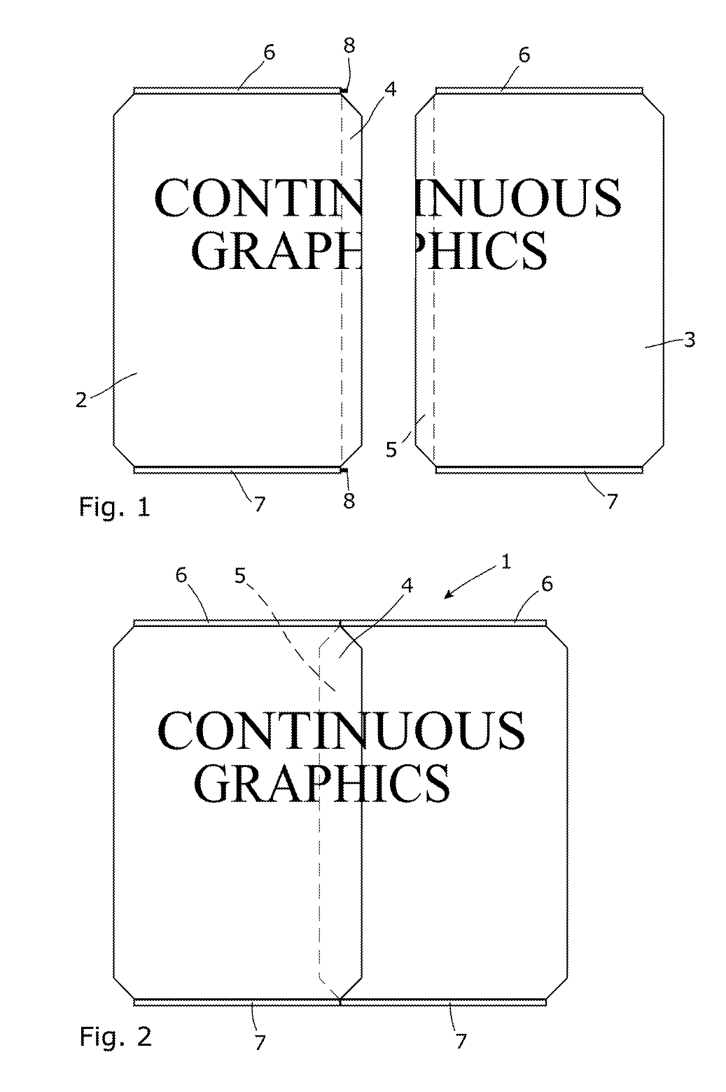

Referring firstly to FIGS. 1 and 2, an embodiment of display arrangement 1 in accordance with the present invention comprises two banners 2 and 3 that are adapted to be displayed side-by side to form a continuous display, as shown in FIG. 2. Typically, these banners 2, 3 will be printed with the required graphical or pictorial information as indicated by the words CONTINUOUS GRAPHICS shown in the drawing. Adjoining edges respectively of the two banners 2 and 3 are adapted to overlap one another by predetermined overlap areas 4 and 5 respectively. When the banners 2, 3 are printed, the overlap areas 4, 5 of each banner are printed with identical material. This means that when the banners 2, 3 are overlapped they form a continuous display, as shown in FIG. 2, so that from a distance it can be hard to detect that the banners 2, 3 are not a single banner. It will be appreciated that this is the case regardless of which banner 2, 3 is placed in front of the other.

The banners 2, 3 can be made of any material suitable for use as a banner. However, preferably the banners are made from a flexible material that can be readily rolled up for storage but that will stay flat when the banners 2, 3 are unrolled for display. In most conventional display arrangements, such material is usually a plastics laminate that can be printed. A highly suitable laminate is one having a layer comprised of polyethylene terephthalate (PET) that is coated with polyvinyl chloride (PVC), preferably on both sides so that the laminate will lie flat when unrolled. This laminate is strong and yet is lightweight and can be readily rolled up for storage and transportation.

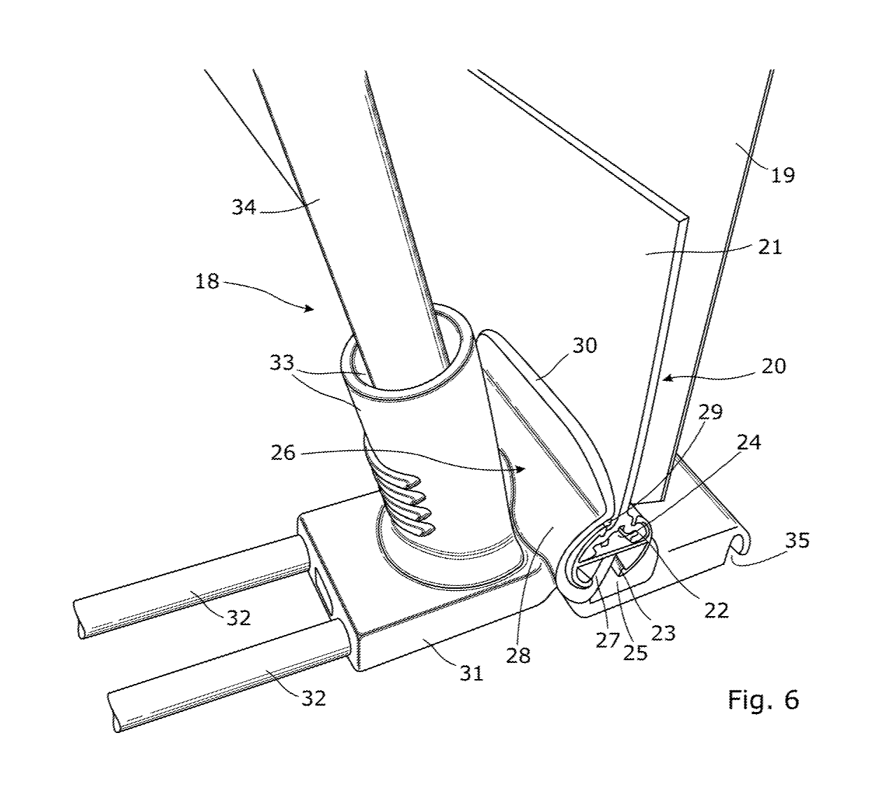

The banners 2, 3 are secured together by means of rods 6. Each banner 2, 3, is secured to a rod 6 along its top edge. The rods 6 are adapted to be connected together in such a way that the banners 2, 3 are aligned and retained in a side-by-side relationship with the predetermined overlap banner areas 5 overlapping one another. Preferably, the banners 2, 3 are attached to similar rods 7 along their lower edges. These rods 6, 7 can be made of any appropriate material and typically will be aluminium or plastics extrusions or be made of carbon fibre. The rods 6, 7 are preferably hollow with slots along their length so that an edge of the banner can be inserted and secured within them. The hollow interior also means that recesses are naturally formed at the ends of the rods 6, 7. Suitable rods 6, 7 are described in more detail below with reference to FIG. 6.

In the present embodiment, the rods 6, 7 are adapted to be connected together by a spigot 8 in a male/female joint. The rods 6, 7 of one of the banners 2 carry spigots 8 that are capable of being inserted into channels or recesses formed at the end of the rods 7, 6 respectively of the other banner 3. Advantageously, the rods 6, 7 are identical and separate spigots 8 are provided that can be pushed into recesses or channels at either end of either of the rods 6, 7 to attach them together. It will be appreciated that the overlap areas 4, 5 of the banners 2, 3 project beyond the ends of the rods 6, 7 to which the banners 2, 3 are secured in a direction parallel to the rods 6, 7. Preferably, the overlap areas 4, 5 are trapezoidal in shape with the parallel sides of the trapezium being normal to the longitudinal axis of the rods 6, 7. This makes for a good appearance when the banners 2, 3 are secured together. However, it will be appreciated that the predetermined overlap areas 4, 5 do not need to be identical in shape, albeit as mirror images of one another, as shown in the drawings. One of these areas, say area 4, could be trapezoidal in shape as described above and as shown in FIGS. 1 and 2. However, the other area 5 need not project beyond the ends of the rods 6, 7 but just comprise the narrow edge strip of the banner 3 that will be overlapped by the area 4 when the rods 6, 7 of each banner are connected. This would mean that some of the banners could be simple rectangles in shape. Again it would not matter whether the banner 2 or the banner 3 were placed in front of the other.

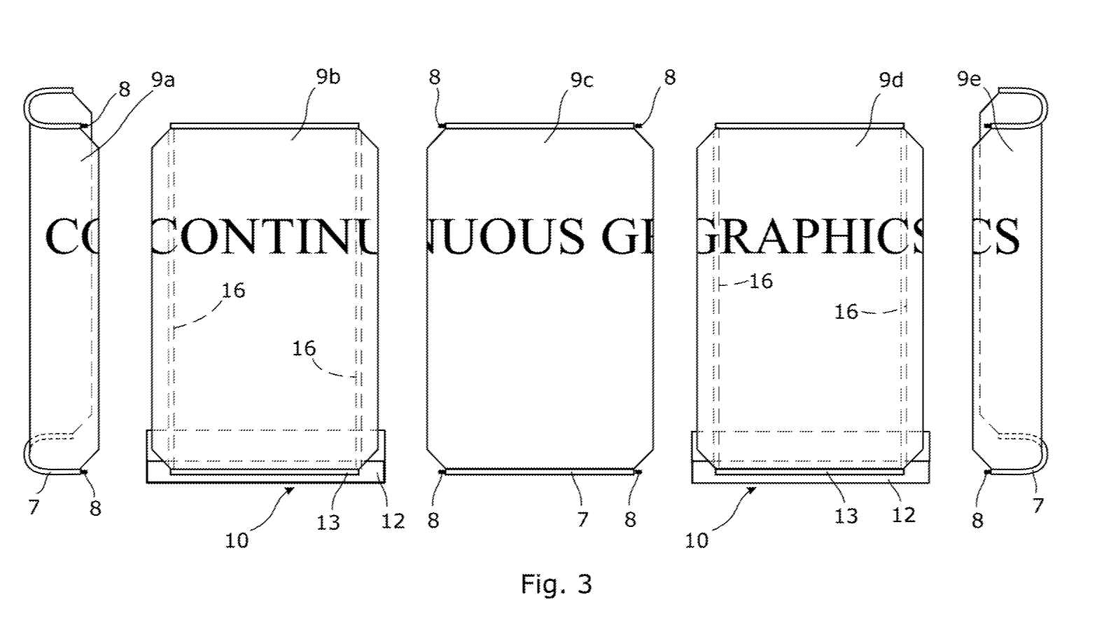

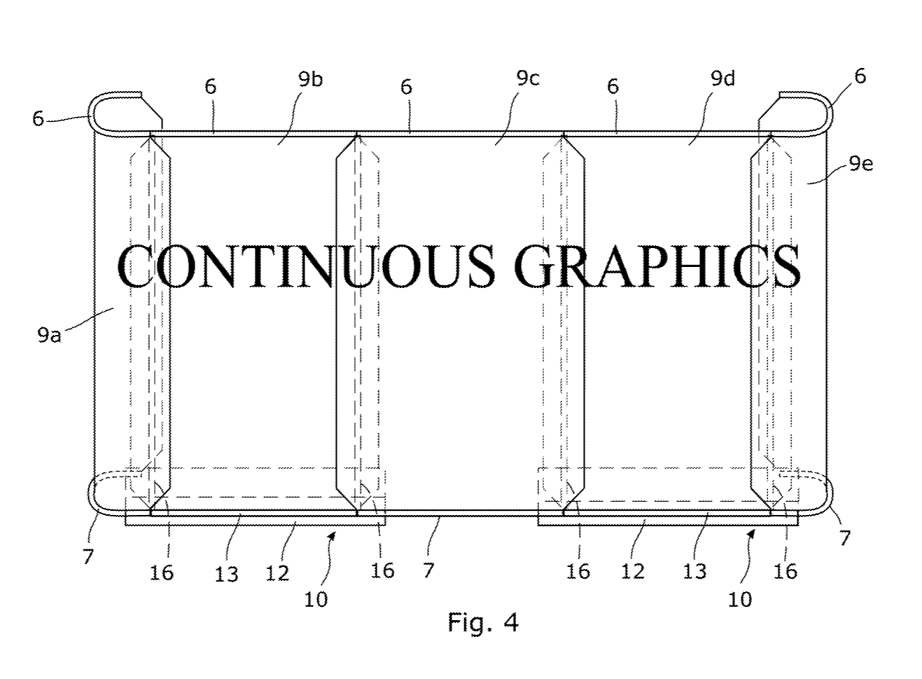

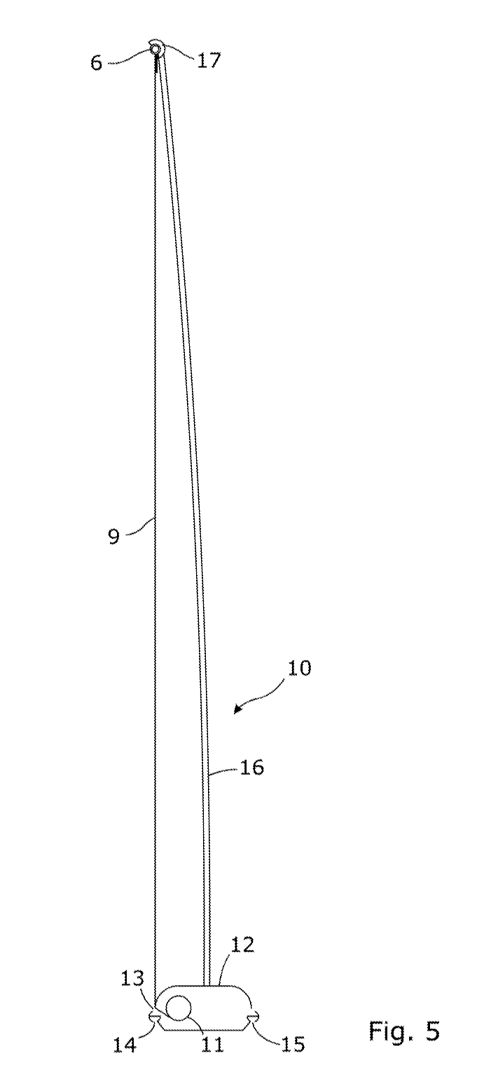

In use, the banners 2, 3 are adapted to be hung from stands, to be attached to a wall or to form part of a roller-banner stand. FIGS. 3 and 4 show a display arrangement comprising five banners 9a to 9e that are similar in shape and construction to those described above with reference to FIGS. 1 and 2. However, in this arrangement the end banners 9a and 9e and the central banner 9c are carried by the other two banners 9b and 9d, which form part of roller-banner stands 10. These stands 10 will now be described in more detail with additional reference to FIG. 5 wherein the banner is labelled 9. However, it will be appreciated that the banners 9b and 9d could be secured to other forms of stands, as will be described with reference to FIG. 6.

In the arrangement shown in FIGS. 3, 4 and 5 the banners 9b and 9d are secured to upper rods 6 as described above. However, at their lower edges the banners 9b and 9d are secured to a roller 11 located within a casing 12 of the stand 10. The casing 12 forms a foot for the stand 10 and is provided with a slit 13 out of which the banner 9 unfurled. In addition, the casing 12 is provided with front recesses 14 at each end to which the rods 7 of adjacent banners 9a, 9c, 9e can be connected via spigots 8 as described above. Preferably, the recesses 14 are provided adjacent the slit 13, as shown in FIG. 5, so that the adjacent banners connect to the casing 12 and can lie within the same plane as the banner 9b, 9d connected to the roller 11. The casing 12 may be provided with other rear recesses 15 into which spigots 8 at the ends of the rods 6, 7 of the two end, recurved banners 9a, 9e of the display may be inserted.

The roller 11 is spring-loaded in the same way as a conventional roller window blind so that it can rotate one way to roll up the banner 9 within the casing 12 when desired for storage or transportation or be rotated in the opposite direction when it is desired to unroll the banner 9 for display purposes. In use, the spring-loading of the roller 11 tensions the banner. The stand 10 is also provided with means to support its banner 9 in the form of two poles 16. The poles 16 fit into recesses (not shown) located at the outer ends of the upper surface of the casing 12 so that they are held upright. The upper end of each pole 16 is adapted to be connected by a clip or bracket 17 that is itself connected to the rod 6 secured to the banner 9. The length of the pole 16 and the height of the banner 9 are matched so that when the pole 16 is connected to the rod 6 it may flex slightly, as shown in FIG. 5, under the force exerted by the spring-loading of the roller 11 via the banner 9.

For a five-banner continuous display arrangement, two stands 10 are required. The banner 9c is supported between the stands 10 by rods 6 and 7 that are connected to the rods 6 and the casings 12 respectively of the banners 9b and 9d by means of spigots 8. The banners 9a and 9e are similar to the banner 9c except that they are adapted to form recurving banners by means of a spring arrangement that cooperates with their rods 6 and 7. They are connected solely to one or other of the strands 10 in the same way but form curving end panels for the display arrangement.

It will be appreciated that a continuous display arrangement in accordance with the invention could be made up of any number of banners, alternate banners being either part of a roller-banner stand 10 (or other stand) or supported by one or more banners forming part of a stand.

An alternative embodiment of stand 18 is shown in FIG. 6 and will now be described in more detail. This stand comprises a banner 19 that is secured, for example by gluing or similar, to a strengthening extrusion 20 formed with a plate portion 21 to which the lower edge of the banner 19 is secured and a connecting portion 22 that is fitted within a rod 23. The rod 23 comprises a substantially hollow extrusion with a transverse cross-sectional profile that defines separate longitudinally extending recesses along the length of the rod. In this embodiment this profile is substantially in the form of an H where the ends of the legs of the H are curved inwards to provide the two longitudinally extending recesses 24, 25. The connecting portion 22 has been slid inside the upper recess 24 of the rod 23 and thereby secured within the upper recess 24. This connects the rod 23 to the banner 19. The upper recess 24 of the rod 23 is also adapted to receive the spigots 8 used to connect the banner 19 to an adjacent banner of a display arrangement.

It should be appreciated that this arrangement of rod 23 and means of connecting the banner 19 to the rod 23 can be used for both the first and second rods 6, 7 and their banners 2, 3, 9 in the embodiments described above with reference to FIGS. 1 to 5 as well as in the present embodiment.

The rod 23 and thereby the banner 19 is clipped to the stand 18 via a bracket 26 that is secured to the stand 18. The bracket 26 comprises a hook 27 that is adapted to engage in the lower recess 25 of the rod 23 and a curved clip 28 that wraps around the exterior of the rod 23. At the top of the clip 28 is a tag 29, which engages in the upper recess 24 of the rod 23 adjacent the extrusion 20, and a finger pull 30. Bending the finger pull 30 away from the banner 19 disengages the tag 29 from the recess 24 and enables the rod 23 and the banner 19 to be disengaged from the bracket 26 and thereby the stand 18.

The stand 18 also comprises a foot 31 that projects forwards for a short distance in front of the rod 23. The foot 31 is provided with two sliding rods 32 that project outwards from the stand 18 at right angles to the banner 19. The rods 32 act as stabilizers for the foot 25 and can be arranged to extend forwards and/or backwards of the stand 18 as appropriate for the location in which it is to be used. Similar stabilizers may also be provided for the stands 10 described above with reference to FIGS. 3 and 4. The foot 31 also comprises a cup 33 for a pole 34 used to support the banner 19 in the same way as the pole 16 described above. The pole 34 is therefore adapted to connect to an upper rod (not shown) secured to the banner 19, which rod may be similar to the rod 23 and be secured to the banner 19 in a similar way. The forwardly-projecting part of the foot 31 may also be provided with a recess 35 so that the stand 18 can be connected by a clip, spigot or similar device to another adjacent stand.

Hence, it will be appreciated that continuous display arrangements can be formed by joining appropriately produced banners together in a side-by-side relationship as described above. In particular, the invention enables roller-banner stands to be used to produce continuous displays. The spigots 8 not only connect adjacent banners together but ensure that the banners are aligned so that the display arrangement gives the appearance of comprising a single banner, the joints between the banners being difficult to discern. However, when it is desired to demount the display, the banners are readily detachable from one another and can be simply rolled up for transportation or storage or rolled up within their casing/stand arrangement. The banners do not need to be detached from the rods 6, 7 or, in the case of the stand 10, from the roller 11.

Such display arrangements can be used as free-standing displays using roller-banner stands 10 or free-standing stands 18 as described above. Alternatively, a continuous display formed as described above with reference to FIGS. 1 and 2 may be hung directly on a wall or partition, for example a partition dividing booths used in an exhibition hall. This is simply achieved by using a hook fastener to secure the upper rods 6 to blocks attached to the wall or partition so that the banners hang a small way clear of the wall or partition to avoid obstructions such as fasteners used to connect the partitions together.

1. A display arrangement comprising at least two banners adapted to be displayed side-by side to form a continuous display, adjacent edges of the banners being adapted to overlap one another by a predetermined overlap area, the overlap area of one banner bearing identical material to the overlap area of the other banner, and each banner being secured to a first rod along another edge thereof, which first rods are adapted to connect together in such a way that the banners are retained in a side-by-side relationship with said predetermined overlap banner areas overlapping one another.

2. An arrangement as claimed in claim 1, wherein the first rods are adapted to connect together by means of a spigot that joins to at least one of the rods in a male/female joint.

3. An arrangement as claimed in claim 2, wherein the spigot projects from one end of one first rod and is capable of being inserted in a channel or recess at one end of the other first rod.

4. An arrangement as claimed in claim 1, wherein the predetermined overlap area of at least one of the banners projects beyond the end of said first rod in a direction parallel to its first rod.

5. An arrangement as claimed in claim 1, wherein the predetermined overlap area of each banner is trapezoidal in shape with the parallel sides of the trapezoidal area being normal to the longitudinal axis of the rod to which the banner is secured.

6. An arrangement as claimed in claim 1, wherein the first rods are secured to top edges of the banner.

7. An arrangement as claimed in claim 1, wherein each banner is secured to a second rod on an edge opposing said other edge, the second rods of the two banners being adapted to be connected together in the same way as said first rods.

8. An arrangement as claimed in claim 1, wherein one of the banners is secured to a second rod on an edge opposing said other edge and the other of the banners is secured to a stand adapted to connect to the second rod of said one banner.

9. An arrangement as claimed in claim 8, comprising three banners wherein two stands each comprising an other banner are provided, the stands being adapted to connect respectively to the ends of the second rod of said one banner whereby said one banner is supported between said stands.

10. An arrangement as claimed in claim 9, wherein the stands comprise roller-banner stands.

11. An arrangement as claimed in claim 8, wherein each stand comprises a casing and the other banner of said stand is secured to a spring-loaded roller that is located within the casing and that is operable to rotate either to roll up said other banner around itself within the casing or to allow withdrawal of the other banner from the casing for display purposes.

12. An arrangement as claimed in claim 8, wherein said first rods are each adapted to be secured to one end of at least one upright pole that supports the banner, the other end of which pole is connected to the stand.

13. An arrangement as claimed in claim 1, wherein the first rods comprise a substantially hollow extrusion within which said other edges of the banners are respectively secured.

14. An arrangement as claimed in claim 13, wherein the first rods have a transverse cross-sectional profile that defines separate longitudinally extending recesses along the length of the rod.

15. An arrangement as claimed in claim 14 wherein one of the recesses is used to secure the banner to the first rod and the other of the recesses is used to receive a spigot to connect the rod to an adjoining first rod.

16. An arrangement as claimed in claim 1, wherein the banners comprise a printable, flexible plastics laminate.

17. An arrangement as claimed in claim 1, wherein the banners comprise a printable flexible laminate made up a layer comprised of polyethylene terephthalate (PET) that has coatings on both sides comprised of polyvinyl chloride (PVC).
